(19) United States
(12) Patent Application Publication
(10) Pub. No.: US 2012/0074901 A1
(43) Pub. Date: Mar. 29, 2012

(54) CENTRALIZED CHARGING STATION

(76) Inventor: Tim Mohammed, Katy, TX (US)

(21) Appl. No.: 13/244,498

(22) Filed: Sep. 25, 2011

Related U.S. Application Data
(60) Provisional application No. 61/386,995, filed on Sep. 27, 2010.

(51) Int. Cl. H02J 7/00

(52) U.S. Cl. 320/109

(57) ABSTRACT

The present invention discloses a centralized charging station (CCS) for rapid charging and discharging of electric vehicles (EVs). The CCS has: (a) a power converter unit (PCU) having: a bidirectional converter for converting an input AC supply to an output DC voltage and vice-versa; and a master control unit (MCU) for regulating operations of the bidirectional converter; (b) one or more vehicle interface power converter units (EVPCUs) for charging and discharging of one or more EVs; and (c) a storage unit interface module (SUIM) for fast charging and discharging of a battery storage unit; the battery storage unit being used for recharging one or more EVs under predefined conditions. The CCS is capable of charging a first set of EVs and discharging a second set of EVs simultaneously.

### CROSS-REFERENCE TO RELATED APPLICATION

This application claims benefit of priority of U.S. Provisional Patent Application Ser. No. 61/386,995, filed 27 Sep. 2010; entitled “ReV2G”, owned by the assignee of the present application and herein incorporated by reference in its entirety.

### FIELD OF THE INVENTION

The present specification relates to a charging station for electrical vehicles. More particularly, the present invention relates to a centralized charging station for charging and discharging electrical vehicles.

### BACKGROUND OF THE INVENTION

An electric vehicle (EV) is one that is powered by stored electric energy originally obtained from an external power source, and uses one or more electric or traction motors for propulsion. Over the years, due to a negative impact on the environment being caused by petroleum based vehicles, a large number of people have been opting for environment friendly EVs. Most EVs are provided with storage units such as batteries and since batteries in use deplete their stored charge, they are required to be re-charged at regular intervals. There is a large variety of charging equipment available for re-charging EVs.

U.S. Patent Application No. 20110077809 discloses a system for charging an electric vehicle comprising: a robotic arm configured for coupling to an electric power source; a docking interface coupled to the robotic arm; an imager coupled to the docking interface and in communication with a controller configured to control a position of the robotic arm; and a plurality of electrical connectors disposed in the docking interface, at least one of the electrical connectors configured for electrical communication with the electric power source.

U.S. Patent Application No. 20110074351 discloses a system for charging an electric vehicle comprising: a rail disposed at a height generally above a vehicle to be charged; a trolley movable along said rail and mounting a movable pulley; a fixed pulley mounted at a fixed position relative to said rail; a power cable communicating at one end with a power source and at an opposed second end with a vehicle terminal connector, said cable looped around said movable and fixed pulleys so that said connector is suspended below said rail; and a spring return device connected with said movable pulley to urge said pulley to a retracted position.

U.S. Patent Application No. 20110074350 discloses a charging system for kiosk operated electric vehicles comprising: an AC charging source connected to a utility grid system; a battery-to-battery DC charging source; a local power bus connected to both the AC and DC charging sources; a plurality of charging stations, each being connected to the local power bus such that power can be received from or transmitted to the local power bus, each charging station having means for connecting to a vehicle battery of one of the kiosk operated electric vehicles; and a system controller being connected to each of the plurality of charging stations, the system controller periodically monitors the condition of the vehicle batteries of all kiosk operated electric vehicles connected to charging stations and selected external sources, using the monitored information the system controller determines a priority for charging the vehicle batteries and the AC or DC charging source to be used for charging the vehicle batteries.

U.S. Patent Application No. 20110031929 discloses an electric supply controller for controlling a switching circuit to connect an electric power supply line to one charger selected from a plurality of chargers, the plurality of chargers being connectable with a plurality vehicles, the electric supply controller comprising: a storage unit configured to associate information on a priority to each of at least part of the plurality of vehicles and configured to store the associated information therein; and a control unit configured to control the switching circuit, when at least part of the plurality of vehicles are simultaneously connected to different chargers, so as to connect the electric power supply line preferentially to one of the different chargers, the one of the different chargers being connected to one of the plurality of vehicles, which is assigned with a highest priority.

U.S. Patent Application No. 20090103341 discloses an AC/DC power module for a plug-in hybrid electric vehicle having an electric drive system and an electric power supply, the power module comprising: a plug connectable to an AC power source; a rectifier having a rectifier input connected to the plug for receiving an alternating current therethrough, the rectifier having a rectifier circuit changing alternating current to direct current, the rectifier having a rectifier output supplying a direct current; a bidirectional DC to DC converter having a first converter terminal operating at a first voltage and a second converter terminal operating at a second voltage that is different than the first voltage, the bidirectional DC to DC converter having a converter circuit changing direct current to or from the first voltage and the second voltage, the first converter terminal connected to the rectifier output; an inductor coil, each of the rectifier and the bidirectional DC to DC converter comprising the inductor when power is utilized therethrough; a battery connected to the first converter terminal and the second converter terminal; and a bus connected to the first converter terminal and the second converter terminal, the bus connectable to the electric drive system.

However, there is need for system and method of re-charging a plurality of EVs simultaneously at a single location in an energy efficient manner. Since most EVs are not used and are parked at various periods of times, their batteries could be used to let electricity flow from the EVs to a utility power grid to support the grid in times of high demand for electric energy. Hence, there is need for a centralized charging station for efficiently re-charging a plurality of EVs as well as for discharging one or more EVs simultaneously, thereby causing electrical energy to flow from the one or more EVs into a power distribution grid.

### SUMMARY OF THE INVENTION

The present invention provides a centralized charging station (CCS) for rapid charging and discharging of electric vehicles (EVs). The CCS comprises: (a) a power converter unit (PCU) comprising: a bidirectional converter for converting an input AC supply to an output DC voltage and converting an input DC voltage to an output AC supply; and a master control unit (MCU) for regulating operations of the bidirectional converter, the MCU providing a communication interface for the CCS; (b) one or more vehicle interface power converter units (EVPCUs) coupled with the PCU and one or more vehicle interface units (VIUs) for charging and discharging of one or more EVs, each EV being connected to the EVPCU via a VIU; and (c) a storage unit interface module (SUIM) coupled with the PCU and a battery storage unit for fast charging and discharging of the battery storage unit; the battery storage unit being used for recharging one or more EVs under predefined conditions. In various embodiments, the CCS is capable of charging a first set of EVs and discharging a second set of EVs simultaneously.

In an embodiment of the present invention, a smart energy management system (EMS) interfacing with the MCU to control charging and discharging of one or more EVs and the battery storage unit; the EMS enabling a flow of electrical energy based on one or more predefined conditions. In another embodiment, the smart EMS interfacing with the CCS manages charging and discharging of each EV allowing a first set of EVs to be charged and a second set of EVs to be discharged simultaneously. The EMS also causes a controlled charging of the battery storage unit based on a set of predefined criteria. In yet another embodiment, the EMS causes one or more EVs to be charged via the battery storage unit based on a set of predefined criteria. In an embodiment, the EMS is coupled with a remote energy control centre (ECC) via a smart communication network.

In an embodiment, the one or more vehicle interface power converter units (EVPCUs) is coupled with the PCU and one or more vehicle interface units (VIUs) for fast (Level III) DC charging and discharging of one or more EVs. Also, in an embodiment, an EV is charged by means of electrical energy flowing from a power distribution grid into a battery of the EV, the power distribution grid being coupled with the CCS. Further, discharging of an EV causes electrical energy to flow from a battery of the EV into a power distribution grid coupled with the CCS. In another embodiment, discharging of an EV causes electrical energy to flow from a battery of the EV into the battery storage unit. In yet another embodiment, an EV is charged by means of electrical energy flowing from the battery storage unit into a battery of the EV and discharging of the battery storage unit causes electrical energy to flow from the battery storage unit into a power distribution grid coupled with the CCS.

In an embodiment of the present invention, the MCU regulates a voltage, frequency, reactive power and a DC bus output and current of the PCU. Also, in an embodiment, each of the EVPCUs comprises a buck-boost DC/DC converter, one or more controllers, an over current protection and a communication system. Further in an embodiment, the VIUs manages charging and discharging of a plurality of EVs having different battery sizes, and each of the VIUs interfaces with a battery management system of an EV for protecting a battery of the EV.

In another embodiment of the present invention, each of the EVPCUs is coupled with the PCU, the EMS and at least one EV for verifying one or more predefined charging and discharging conditions. In an embodiment, the SUIM comprises a buck-boost DC/DC converter, one or more controllers, an over current protection and a communication system.

Further, in an embodiment of the present invention, the CCS comprises a utility transformer for coupling the CCS to a local utility power distribution grid and a main circuit breaker for providing short circuit protection to the CCS; the main circuit breaker isolating the CCS from the power distribution grid during power faults.

### BRIEF DESCRIPTION OF THE DRAWINGS

These and other features and advantages of the present invention will be further appreciated, as they become better understood by reference to the detailed description when considered in connection with the accompanying drawings:

FIG. 1 illustrates a block diagram of the centralized charging station (CCS), in accordance with an embodiment of the present invention;

FIG. 2 is a block diagram illustrating a CCS power system topology, in accordance with an embodiment of the present invention;

FIG. 3 is a block diagram illustrating a CCS control system topology, in accordance with an embodiment of the present invention;

FIG. 4 is a flowchart depicting the steps followed by electric vehicle power converter units (EVPCU) of the CCS in a charging mode, in accordance with an embodiment of the present invention; and

FIG. 5 illustrates a control circuit of the CCS enabling charging a first set of EVs and discharging a second set of EVs simultaneously, in accordance with an embodiment of the present invention.

### DETAILED DESCRIPTION

The present invention is directed towards a centralized charging station (CCS) for charging a plurality of electrical vehicles (EVs) from a standard power distribution grid coupled with the CCS.

The present invention is also directed towards a CCS for discharging a plurality of EVs by causing electrical energy to flow from the EVs to a standard power distribution grid coupled with the CCS.

The present invention is also directed towards a centralized charging station (CCS) for charging a battery storage unit from a standard power distribution grid coupled with the CCS.

The present invention is also directed towards a CCS for discharging a battery storage unit by causing electrical energy to flow from the battery storage unit to a standard power distribution grid coupled with the CCS.

The present invention is also directed towards a CCS for charging and discharging a plurality of EVs, where the CCS is coupled with an enterprise SCADA communication system.

The present invention is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

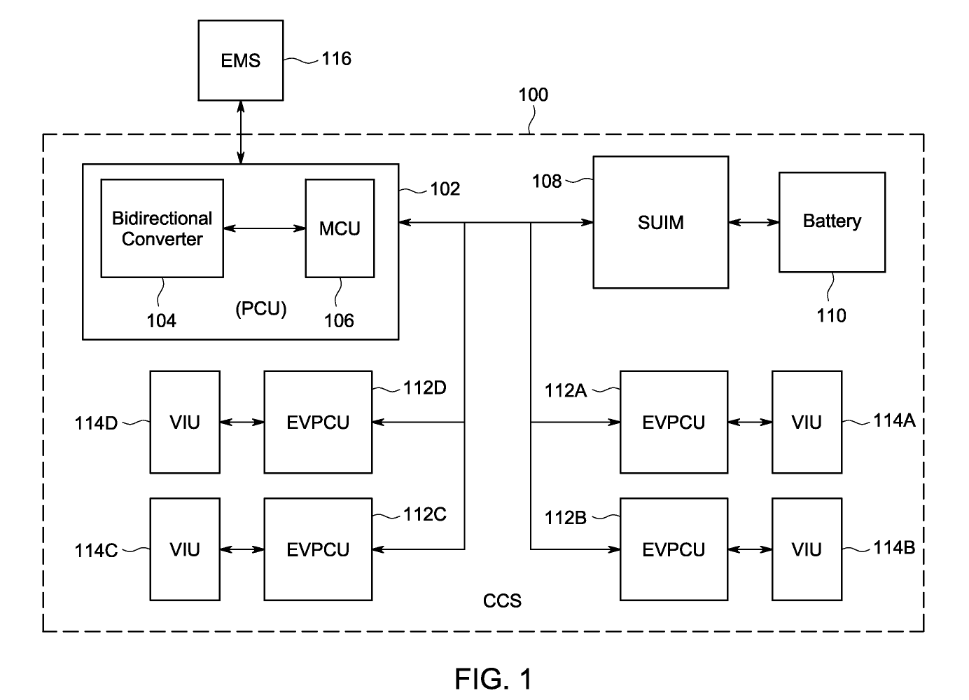

FIG. 1 illustrates a block diagram of the centralized charging station (CCS) 100 of the present invention. In an embodiment, the CCS 100 is used for Level 3 (rapid DC Charging) recharging and discharging of all types of electric and plug-in hybrid electric vehicles (EVs). The CCS 100 comprises a main power converter unit (PCU) 102, a storage unit interface module (SUIM) 108, a storage unit 110, a plurality of electric vehicle power converter units (EVPCU) 112, and a plurality of vehicle interface units (VIU) 114. The CCS 100 is coupled with a smart energy management system (EMS) 116. In an embodiment, the EMS 116 receives real time energy states of each EV and battery storage unit 110, sends dispatch commands to the CCS 100, and determines which of the EVs require to be charged and which to be discharged.

In an embodiment, the CCS 100 integrates with the on-site storage unit interface module (SUIM) 108 for recharging and discharging the utility scale energy storage unit (SU) 110 comprising batteries. The CCS 100 manages the energy flow states and has an integrated demand response (DR) and Vehicle-2-Grid (V2G) capabilities.

The main PCU 102 comprises a bidirectional AC/DC/AC converter 104 and a master control unit (MCU) 106. In an embodiment, the PCU 102 is coupled with a standard power distribution grid. In various embodiments, the bidirectional AC/DC/AC converter 104 converts three-phase, distribution level, 50 or 60 Hz alternate current (AC) power source to a DC power output and vice versa. The MCU 106 functions as a communication interface for the CCS 100. The MCU 106 receives commands from the EMS 116 and sends signals to a plurality of gate drives (not shown in FIG. 1) of the PCU 102 to regulate the operation of the bidirectional converter 104. The PCU 102 also regulates a DC bus output and current, reactive power, voltage and frequency of the power supplied from or to the distribution grid.

The PCU 102 is coupled with a plurality of EVPCU 112, and each EVPCU 112 is coupled with a VIU 114 which in turn is coupled with an electric vehicle (EV) for charging and discharging the EV. In various embodiments, the CCS 100 is capable of charging a plurality of EVs simultaneously. Further, in various embodiments, the CCS 100 charges a first set of EVs and discharges a second set of EVs simultaneously. In an embodiment, each of the EVPCUs comprise a buck-boost DC/DC converter, one or more controllers, an overcurrent protection and a communication system. Each VIU 114 provides an interface between the EV and the PCU 102. In a specific embodiment, each VIU 114 power is rated at or greater than 50 KW and 20 or more VIUs may be connected to a single PCU 102. As would be apparent to a person of skill in the art various other power configurations of the VIU 114 are possible. The EVPCU 112 and VIU 114 manage the recharging and discharging of EVs of various battery sizes, provide converter protection and also interface with an EV battery management system for providing battery protection. In and embodiment, the VIU 114 interfaces with the PCU 102 and the EMS to verify an EV owner's identification information and charging preferences thereby causing the EV to be charged in accordance with the pre-fed charging specifications.

In an embodiment, the SUIM 108 is used to recharge and discharge a utility scale battery storage unit (SU) 110. The SUIM 108 functions to optimize the use of the PCU 102 and allows the CCS 100 to provide peak shaving and power shifting capabilities. In an embodiment, the SUIM 108 comprises one or more buck-boost DC/DC converter(s), one or more controllers, an overcurrent protection and a communication system. In various embodiments, the SUIM 108 manages the charging and discharging of the SU 110, and interfaces with the SU 110 battery management system for providing battery protection. In various embodiments, the battery SU 110 is used to provide a second source to charge the EVs during peak demand hours, thereby reducing a load on the power distribution grid. The recharging of SU 110 could be managed to occur during off-peak hours when renewable resources such as wind power is abundant.

In various embodiments, the smart EMS 116 interfaces with the MCU 104 to control charging and discharging of a plurality of EVs and the battery SU 110 based on one or more predefined conditions. During peak demand, energy from the SU 110 and a predetermined number of EVs flows back to the grid coupled with the PCU 102 such as in a standard Vehicle-to-Grid (V2G) and Storage-to-Grid (S2G) operations. Further, the EMS 116 regulates the re-charging of the SU 110 during off peak demand. In an embodiment, the CCS 100 comprises a smart IP communications network to interface with a remote energy control center (ECC) which houses the EMS 116. In various embodiments the CCS 100 has the following functions:
manage power flow between and from each EV independently allowing for some EVs to be charged while others to be discharged simultaneously;
control the charging of each EV independently in current mode only or voltage mode only; and causing the transition from current control to voltage control mode as well as from voltage control to current control mode smoothly;
cause fast switching from charge to discharge control as well as from discharge to charge control.
full, independent control of reactive power (Q) and real power (P)
control terminal Voltage (V) and frequency (F) to support the power distribution grid during short disturbances.

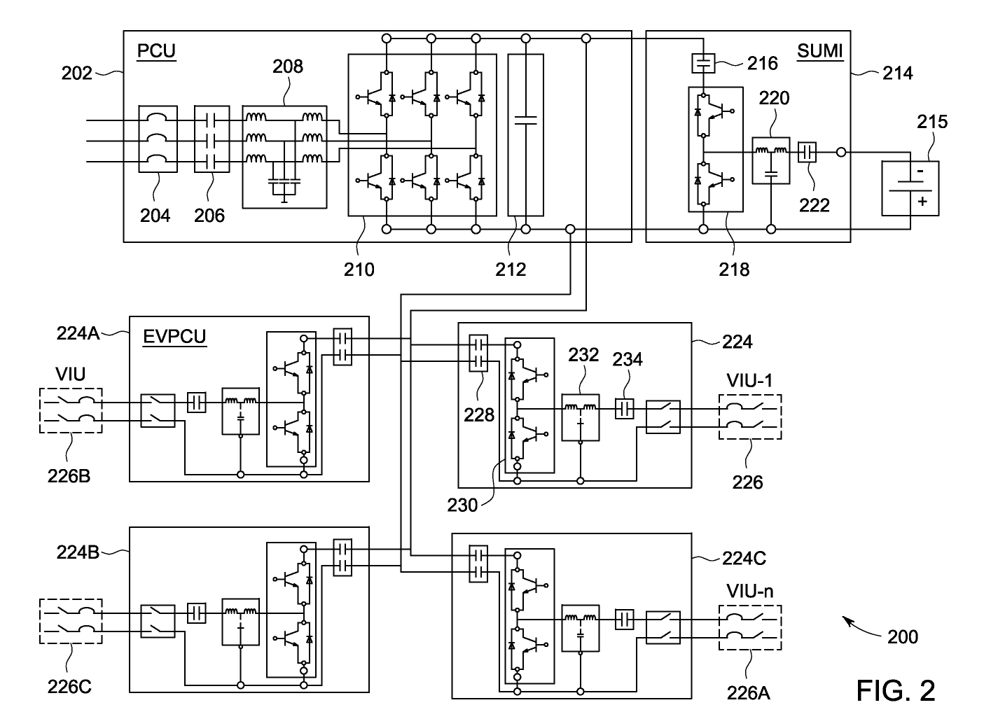

FIG. 2 is a block diagram illustrating a CCS power system topology, in accordance with an embodiment of the present invention. A PCU 202 of the CCS 200 connects to a local utility power distribution grid, which in an embodiment, is used to transform three phase distribution 50 or 60 HZ AC voltage (Vin) to a constant DC voltage. A main circuit breaker (MCB) 204 provides overcurrent and short circuit protection and isolates the CCS 200 from the power distribution grid during power faults. A synchronization contractor (SC) 206 is used to synchronize the CCS 200 output with the power distribution grid. The MCB 204 provides overcurrent protection. A line filter (LF) 208 is used to dampen harmonics generated by switching of insulated gate bipolar transistors (IGBTs) 210, which convert the AC source voltage to a constant DC voltage and vice versa. The IGBTs 210 comprise snubber diodes that are used to reduce conducting and switching losses. In an embodiment, high performances IGBTs 210 are used and switched at high frequency for low d/dt at turn off to reduce losses. In an embodiment, a pulse width modulation (PWM) technique is employed in the CCS 200. A dc Link (DCL) capacitor 212 provides decoupling between the PCU 202 and other portions of the CCS 200.

As illustrated in FIG. 2, in an embodiment, a storage unit interface module (SUIM) 214 is coupled with the PCU 202 for recharging and discharging of a battery storage unit (SU) 215. An enable contactor (SUIM-EC) 216 is used to connect the SUIM 214 to the PCU 202. The SUIM 214 comprises a power control unit comprising a buck-boost DC/DC converter (SUIM-PCU) 218, an SUIM filter (SUIM-F) 220 and a charging contactor (SUIM-CC) 222. In an embodiment, the SUIM further comprises gate driver boards, main control boards, overcurrent protection, and communication equipment.

Further, as illustrated the CCS 200 comprises one or more vehicle power converter units EVPCU 224, 224A, 224B, 224C and one or more vehicle interface units (VIUs) 226, 226A, 226B, 226C. Each EVPCU 224, 224A, 224B, 224C comprises an enable contactor (EVPCU-EC) 228 a buck-boost power converter unit (EVPCU-PCU) 230, a filter (EVPCU-F) 232 to attenuate undesired current harmonics caused by the (EVPCU-PCU) 228, and a charging contactor (EVPCU-CC) 234. In an embodiment, each of the EVPCUs 224, 224A, 224B, 224C further comprise one or more communication interfaces, overcurrent protection, grounding and bonding equipment. Also in various embodiments, each of the VIU 226, 226A, 226B, 226C comprises an over current protection, control and communications system designed to interface with an EV using a standard fast charging cable.

Table 1 illustrates power ratings for the CCS 200 in accordance with an embodiment of the present invention:

CCS Rating

| | | |
|---|---|---|
| Power (S) | 100, 200, 400, | KVA |
| | 800, 1000 | |
| Input Voltage (V) | 480 +/− 10% | Volt AC |
| Frequency (F) | 50 or 60 +/− 5% | Hz |
| DC link Voltage (V_{dc}) | 50 to 700 | Vdc |
| Switching frequency (f_{sw}) | 5 | kHz |

Table 2 illustrates power ratings for the SUIM 214, in accordance with an embodiment of the present invention:

SUIM Rating

| | | |
|---|---|---|
| Power (S) | 100, 200, 400, | KVA |
| | 800, 1000 | |
| Input Voltage during charging (V_{dc}) | 600 +/− 10% | Vdc |
| Max. Charging Current | 1666 | A |
| Switching frequency (f_{sw}) | 5 | kHz |

Table 3 illustrates power ratings for each VIU 224 or 226, in accordance with an embodiment of the present invention:

Single VIU Rating

| | | |
|---|---|---|
| Power (S) | 50 | KVA |
| Input Voltage during charging (V_{dc}) | 700 +/− 10% | Vdc |
| Switching frequency (f_{sw}) | 5 | kHz |
| Battery voltage (V_{bat}) | 400 | Vdc |
| Charging Current | 125 | A |

In various embodiments, the PCU 202 is designed in a plurality of sizes for being used in a plurality of applications. Table 4 illustrates PCU configurations, in accordance with an embodiment of the present invention:

| PCU Model | Rate Power (KW) | MAX. # Of VIU | SU Power (KW) |
|---|---|---|---|
| PCU-100 | 100 | 2 | 100 |
| PCU-200 | 200 | 4 | 200 |
| PCU-300 | 300 | 6 | 300 |
| PCU-400 | 400 | 8 | 400 |
| PCU-500 | 500 | 10 | 500 |
| PCU-600 | 600 | 12 | 600 |
| PCU-700 | 700 | 14 | 700 |
| PCU-800 | 800 | 16 | 800 |
| PCU-900 | 900 | 18 | 900 |
| PCU-1000 | 1000 | 20 | 1000 |

As illustrated in Table 4, a power rating of a PCU changes based on a maximum number of VIUs the PCU can support and power rating of an SU the PCU can recharge. For example, a PCU having a power rating of 300 KW can support a maximum of 6 VIUs and can recharge a SU having a power rating of 300 KW; whereas a PCU having a power rating of 900 KW can support a maximum of 18 VIUs and can recharge a SU having a power rating of 900 KW.

As would be apparent to a person of skill in the art, the power ratings and CCS configurations illustrated in Tables 1-4 are only exemplary and illustrative. In various embodiments of the present invention, various other power ratings and configurations of the CCS may be employed to achieve a desired result without departing from the spirit and scope of the appended claims.

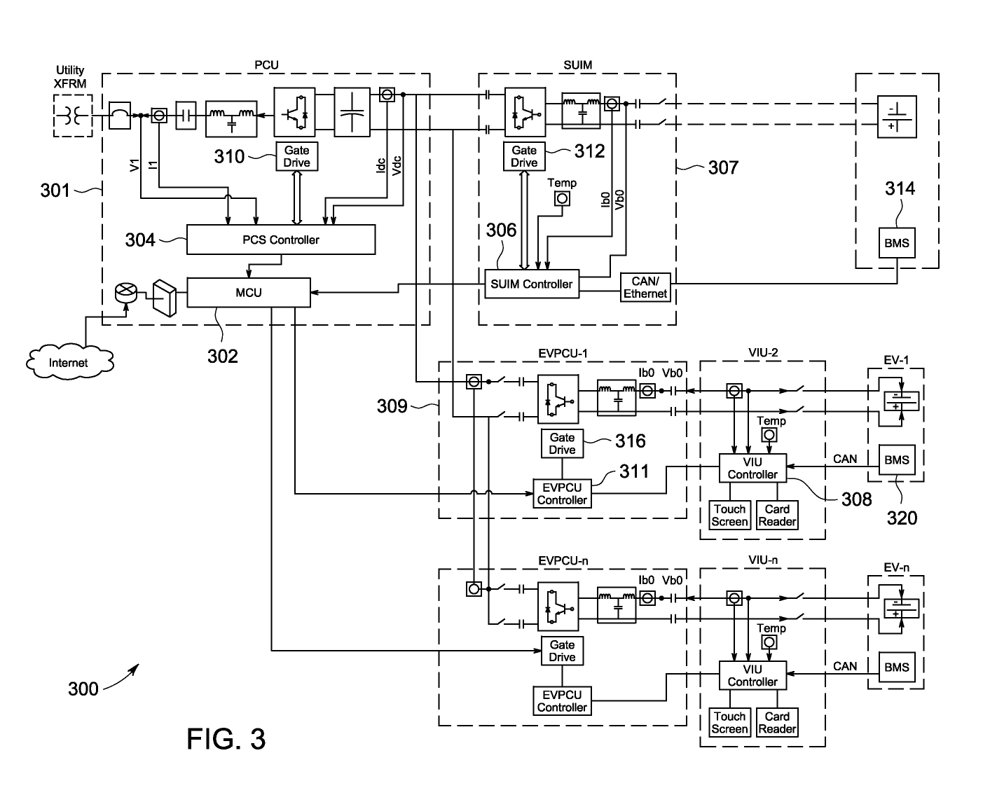

FIG. 3 is a block diagram illustrating a CCS control system topology, in accordance with an embodiment of the present invention. As illustrated in FIG. 3, the Master Control Unit (MCU) 302 is a microprocessor computer system used for controlling the operation of the CCS 300. The MCU 302 communicates with PCU controller 304, SUIM controller 306, VIU controller 308 and EVPCU controller 311. In various embodiments the MCU 302 is used to:
receive via a smart grid IP charging and discharging commands from an EMS (not shown in FIG. 3) and send the received commands to the PCU controller 304, the SUIM controller 306, the VIU controller 308 and the EVPCU controller 311.
receive real time data such as state-of-charge (SOC) of EV batteries from the SUIM controller 306 and the VIU controller 308 to control charging modes of the EV batteries.
   The PCU controller 304 communicates with PCU gate drive board 310 to regulate an output voltage and current of PCU 301, and controls the terminal reactive power and frequency. The PCU controller 304 also provides the PCU 301 with over current, over voltage over temperature and over frequency protection. The SUIM controller 306 receives charge and discharge states from the EMS via the MCU 302 and communicates with the SUIM gate drive board 312 to regulate the operation of the buck-boost converter voltages and current. The SUIM controller 306 provides SUIM 307 with over current, over voltage and over temperature protection and is in real-time communication with the storage unit (SU) battery management system 314 via a bus link. The MCU 302 receives charge and discharge states from the EMS and communicates the same to the EVPCU 309. The EVPCU controller 311 communicates with the EVPCU-PCU gate drive board 316 to regulate the buck-boost converter charge and discharge states and controls voltage and current modes. The EVPCU controller 311 provides EVPCU 309 with over current, over voltage and over temperature protection. The EVPCU controller 311 is in real-time communication with EV battery management system 320 via VIU controller 308. The VIU controller 308 comprises a card reader and a touch screen for user interface.

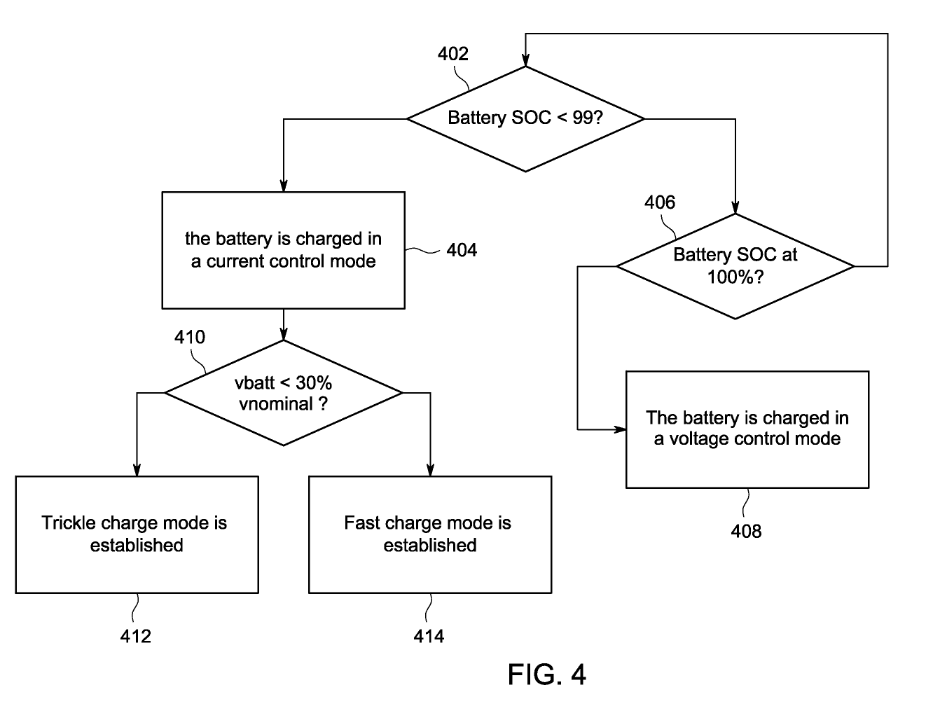

FIG. 4 is a flowchart depicting the steps followed by an EVPCU of the CCS in a charging mode, in accordance with an embodiment of the present invention. The state of charge (SOC) of a battery is measured and is used to determine whether the battery is charged in a current mode or in a voltage mode. At step 402 it is determined if the battery SOC is less than 99%. If the battery SOC is less than 99%, the battery is charged in a current control mode at step 404. Else it is determined at step 406 if the battery SOC is at 100%. If the battery SOC is at 100%, the battery is charged in a voltage control mode at step 408. In an embodiment of the present invention, in the current control mode comprises a trickle charge mode and a fast charging mode, which are triggered based on a voltage level of the battery. At step 410 it is determined if the battery voltage is less than the 30% of a nominal voltage (vbatt<30% vnominal). If the battery voltage is less than the 30% of a nominal voltage (vbatt<30% vnominal) then at step 412 a trickle charge state is established. In the trickle charge mode, the current reference is set to 30% of a battery current. If the battery voltage is greater than the 30% of a nominal voltage (vbatt>30% vnominal) then at step 414 a fast current charge mode is established.

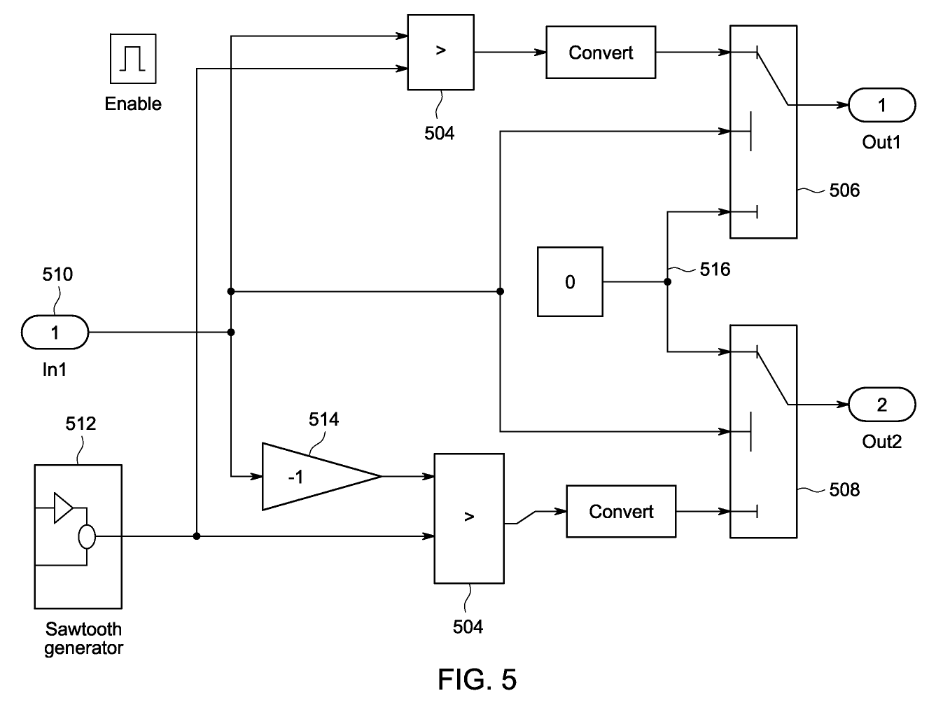

FIG. 5 illustrates a control circuit of the CCS enabling charging a first set of EVs and discharging a second set of EVs simultaneously, in accordance with an embodiment of the present invention. The control circuit 500 comprises comparators 502 and 504 and switches 506 and 508. An input error signal 510 and a signal generated by a saw tooth generator 512 are fed to the comparator 502. The input error signal 510 is multiplied by −1 using multiplier 514 before being fed to the comparator 504 along with the signal generated by the saw tooth generator 512. The comparators 502 and 504 perform a pulse width modulation (PWM) of their respective input signals. The output signal of comparator 504 is inverse of the output signal of the comparator 502. The output signals of the comparators 502 and 504 are fed to switches 506 and 508 respectively along with a control signal 516 and the output signal of the saw tooth generator. This causes only one of the switches 506 and 508 to be in an ON state at any given instance of time. In an embodiment, the output signal of switch 506 is fed to a buck terminal of a DC/DC converter of the CCS whereas the output signal of switch 508 is fed to the boost terminal of the same DC/DC converter. This causes the CCS to be able to charge a first set of EVs and discharge a second set of EVs simultaneously.

In an embodiment, the CCS of the present system is coupled with a supervisory control and data acquisition (SCADA) system. As is known in the art a SCADA system is a computer system for gathering and analyzing real time data. In the present invention, the enterprise SCADA system comprises data collection devices, servers, and telecommunications hardware necessary to transmit and receive real-time data and to make energy charging and discharging decisions and issue commands to field devices. The SCADA system also enables the CCS operators to monitor and optimize the operations and performance of the energy storage units of the CCS.

In various embodiments the SCADA system interface with the CCS of the present invention performs at least the following functions:
Receives dispatch and regulations commands
Interfaces with energy market to get energy rates
Interfaces with a client server to get charging and discharging preferences
Based on an intelligent logic it determines the most profitable and efficient method to meet the dispatch commands
Instructs operators controller installed at energy storage sites to execute sent commands
Collects real time data from all energy storage modules across enterprise
Provides a dashboard for quick review of system modules
Generates alerts to notify personnel of any alarming status of any module of the CSS
Allows storage of collected data for any predefined period
Provides analysis option for corrective action to increase performance
Provides scalability to incorporate new projects
Provides remote control capability such as Start, Stop, Pause, and Reset

Hence, the present invention provides a CCS for efficiently charging a plurality of EVs directly via a power distribution grid as well as via a battery storage unit which in turn is charged via the power distribution grid. The CCS of the present invention also provides for discharging a plurality of EVs and the battery storage energy causing electrical energy to flow into the power distribution grid thereby supporting the grid. The CCS of the present invention comprises a smart control unit for regulating the operations of the CCS and causing the charging of the battery storage unit to occur during times when there is minimal load on the grid. The smart control unit also causes one or more EVs to be charged via the battery storage unit during times when there is a maximum load on the power distribution grid.

The above examples are merely illustrative of the many applications of the system of present invention. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

We claim:

1. A Centralized Charging Station (CCS) for rapid charging and discharging of electric vehicles (EVs) comprising:
a. a power converter unit (PCU) comprising:
i. a bidirectional converter for converting an input AC supply to an output DC voltage and converting an input DC voltage to an output AC supply; and
ii. a master control unit (MCU) for regulating operations of the bidirectional converter, the MCU providing a communication interface for the CCS;
b. one or more vehicle interface power converter units (EVPCUs) coupled with the PCU and one or more vehicle interface units (VIUs) for charging and discharging of one or more EVs, each EV being connected to the EVPCU via a VIU; and
c. a storage unit interface module (SUIM) coupled with the PCU and a battery storage unit for fast charging and discharging of the battery storage unit; the battery storage unit being used for recharging one or more EVs under predefined conditions;
the CCS being capable of charging a first set of EVs and discharging a second set of EVs simultaneously.

2. The CCS as claimed in claim 1 interfaces with a smart energy management system (EMS) to control charging and discharging of one or more EVs and the battery storage unit; the EMS enabling a flow of electrical energy based on one or more predefined conditions.

3. The CCS as claimed in claim 1 wherein the one or more vehicle interface power converter units (EVPCUs) is coupled with the PCU and one or more vehicle interface units (VIUs) for fast (Level III) DC charging and discharging of one or more EVs.

4. The CCS as claimed in claim 1 wherein an EV is charged by means of electrical energy flowing from a power distribution grid into a battery of the EV, the power distribution grid being coupled with the CCS.

5. The CCS as claimed in claim 1 wherein discharging of an EV causes electrical energy to flow from a battery of the EV into a power distribution grid coupled with the CCS.

6. The CCS as claimed in claim 1 wherein discharging of an EV causes electrical energy to flow from a battery of the EV into the battery storage unit.

7. The CCS as claimed in claim 1 wherein an EV is charged by means of electrical energy flowing from the battery storage unit into a battery of the EV.

8. The CCS as claimed in claim 1 wherein discharging of the battery storage unit causes electrical energy to flow from the battery storage unit into a power distribution grid coupled with the CCS.

9. The CCS as claimed in claim 1 wherein the MCU regulates a voltage, frequency, reactive power and a DC bus output and current of the PCU.

10. The CCS as claimed in claim 1 wherein each of the EVPCUs comprises a buck-boost DC/DC converter, one or more controllers, an overcurrent protection and a communication system.

11. The CCS as claimed in claim 1 wherein the VIUs manages charging and discharging of a plurality of EVs having different battery sizes.

12. The CCS as claimed in claim 1 wherein each of the VIUs interfaces with a battery management system of an EV for protecting a battery of the EV.

13. The CCS as claimed in claim 1 wherein each of the EVPCUs is coupled with the PCU, the EMS and at least one EV for verifying one or more predefined charging and discharging conditions.

14. The CCS as claimed in claim 1 wherein the SUM comprises a buck-boost DC/DC converter, one or more controllers, an overcurrent protection and a communication system.

15. The CCS as claimed in claim 2 wherein the smart EMS manages charging and discharging of each EV allowing a first set of EVs to be charged and a second set of EVs to be discharged simultaneously.

16. The CCS as claimed in claim 2 wherein the EMS causes a controlled charging of the battery storage unit based on a set of predefined criteria.

17. The CCS as claimed in claim 2 wherein the EMS causes one or more EVs to be charged via the battery storage unit based on a set of predefined criteria.

18. The CCS as claimed in claim 2 wherein the EMS is coupled with a remote energy control centre (ECC) via a smart communication network.

19. The CCS as claimed in claim 1 further comprises a utility transformer for coupling the CCS to a local utility power distribution grid and a main circuit breaker for providing short circuit protection to the CCS; the main circuit breaker isolating the CCS from the power distribution grid during power faults.
